(19) United States
(12) Patent Application Publication
(10) Pub. No.: US 2004/0030621 A1
(43) Pub. Date: Feb. 12, 2004

(54) Method of reconciling credit union corporate accounts

(76) Inventor: Keith B. Cobb, Baltimore, MD (US)

Correspondence Address: Royal W. Craig, Law Offices of Royal W. Craig, Suite 153, 10 N. Calvert Street, Baltimore, MD, 21202, US

(21) Appl. No.: 10/214,806

(22) Filed: Aug. 7, 2002

(51) Int. Cl. G06F 17/60

(52) U.S. Cl. 705/35

(57) ABSTRACT

A method implemented in software form for reconciling a credit union member's monthly G/L Statement with the Corporate Statement of a corporate credit union. The method generally comprises the steps of inputting the G/L Statement and the Corporate Statement data, reformatting and indexing the same in a particular manner, and performing a sort routine on the indexed, thereby sorting said data into discrete records according to transaction type. A number of pre-determined reports are available inclusive of those in which each sorted and indexed record from the G/L Statement is compared with a corresponding sorted and indexed record from the Corporate Statement data, inclusive of preliminary reconciliation reports compiled from the matching record(s) and unmatched records. The preliminary reconciliation reports are canvassed for matching errors and, once corrected, final reconciliation reports are output. The segregating and indexing of the above-described method reduces the number of machine code comparisons significantly and speeds processing time.

### CROSS-REFERENCE TO RELATED APPLICATIONS

The present application derives priority from U.S. provisional application No. 60/310,601 for “METHOD OF RECONCILING CREDIT UNION CORPORATE ACCOUNTS”; Filed: Aug. 7, 2001.

### BACKGROUND OF THE INVENTION

1. Field of the Invention

The present invention relates to reconciliation of Credit union corporate accounts and, more particularly, to an improved method of reconciling the general ledger statement (G/L Statement) to similar like items from the Corporate Statement, and vice versa.

2. Description of the Background Credit unions are nonprofit, cooperative financial institutions that are owned and run by their members. Organized to serve, democratically controlled credit unions provide their members with a safe place to save and borrow at reasonable rates. Members pool their funds to make loans to one-another. Today, over 10,500 credit unions with assets in excess of $30 billion serve 70 million people in the United States. This explosive growth has fueled a demand for auditors, accountants, and improved tools to attend to the financial work. Specifically, reconciling corporate accounts month after month can be overwhelming. Nevertheless, account reconciliations must be prepared promptly, accurately, and at a reasonable cost. Currently, these auditing functions are performed by hand by accountants who specialize in credit union account reconcilements. Unfortunately, nearly 50% of all credit unions either do not reconcile their corporate account at all, or they don't do it correctly. Of those that accurately reconcile the corporate account, many do not properly utilize the information that is gained from the reconciliation. For example, many do not research the outstanding items or do they realize that the reconciliation can assist them in pricing returned checks, money orders, etc.

It would be greatly advantageous to provide a computerized process of reconciling the corporate credit union monthly statement with the credit union's corporate account.

There are prior reconciliation methods for account statements, but none capable of handling the particular types of transactions that are peculiar to corporate credit unions, or the volume of such transactions.

For example, U.S. Pat. No. 6,138,118 to Koppstein et al. discloses a method and system for reconciling concurrent streams of transactions in a database. The reconciliation step includes reconciling a high priority stream of transactions that is concurrent with a low priority stream of transactions. This is accomplished by establishing the high priority stream in the database, establishing the low priority stream in temporary storage, and reconciling the low priority stream with the high priority stream.

Likewise, U.S. Pat. No. 6,047,887 to Rosen discloses a system and method for connecting money modules that includes reconciliation and clearing processes to monitor and balance a monetary system. The reconciliation processes ensure that deposits, withdrawals and payments, match the appropriate accounting transactions.

Despite the advantages gained by the use of software as a tool to quickly and accurately reconcile accounts, neither of the foregoing nor any other known computer methods are capable of quickly and accurately reconciling a corporate credit union monthly statement with the corporate account.

It would be greatly advantageous to provide a computerized method of matching like items from the monthly statement to similar like items from the corporate account and vice versa, and a novel way of reporting the results. This would provide for segregation of duty, an audit trail, a detailed history of the various types of activity that pass through the corporate account, and many other advantages.

### SUMMARY OF THE INVENTION

Accordingly, it is an object of the present invention to provide a computerized method of matching like items from the general ledger statement (G/L Statement) to similar like items from the Corporate Statement and vice versa.

It is another object to provide a method of reconciliation for the corporate account that provides for better accounting via segregation of duty, audit trails and detail histories (by transaction type) included within the reconciliation process.

It is a more specific object to provide an automated reconciliation program designed to reconcile the G/L Statement and the Corporate Statement, the advantages being reduced time and effort, more accuracy compared to manual procedures, total factuality because of the segregation of duty, and the ability to provide trend information.

It is another object to provide a method of reconciliation that reduces the number of machine code comparisons and speeds processing time.

According to the present invention, the above-described and other objects are accomplished by providing a method for reconciling a monthly G/L Statement and Corporate Statement of a corporate credit union. The method is implemented in software form and generally comprises the steps of inputting the G/L Statement and the Corporate Statement data, reformatting and indexing the same in a particular manner, and performing a sort routine on the indexed, thereby sorting said data into discrete records according to transaction type. A number of pre-determined preliminary reports are available inclusive of those in which each sorted and indexed record from the G/L Statement is compared with a corresponding sorted and indexed record from the Corporate Statement data. In this manner, preliminary reconciliation reports are compiled from the matching record(s) and unmatched records. Preferably, the preliminary reconciliation reports are canvassed either manually or automatically for matching errors. Once the matching errors are corrected, final reconciliation reports are output. The segregating and indexing of the above-described method reduces the number of machine code comparisons significantly and speeds the processing time.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 illustrates a flow chart of the method according to the present invention.

FIG. 2 is an example page from a G/L Statement.

FIG. 3 is an example page from a Corporate Statement.

FIG. 4 is a resultant printout of the record containing the general ledger data for mixed deposits after both the first sort and indexing.

FIGS. 5-19 generally are screen prints illustrating the various navigation choices and reports made available to the user.

Specifically, FIG. 5 is a Navigation Menu made available to the user.

FIG. 6 is a drop-down list of file operation sub-commands.

FIG. 7 is a drop-down list of statement sub-commands.

FIG. 8 is an indexed G/L Statement printout.

FIG. 9 is a drop-down list of G/L-related reports.

FIG. 10 is a DEBIT report for the G/L Statement.

FIG. 11 is a detailed report of postings for the G/L Statement.

FIG. 12 is a drop-down list of Corporate Activities.

FIG. 13 is a listing of credit entries.

FIG. 14 is a detailed report of postings for the G/L Statement.

FIG. 15 is a drop-down list of calendar months.

FIG. 16 is a drop-down list of report types.

FIG. 17 illustrates the Final Report which is a complete Reconciliation statement.

FIG. 18 is a report prepared from the matching transaction records of ACH POSTING (on the G/L Statement side) and FRB ACH (on the Corporate Account side).

FIG. 19 is a report prepared from the unmatched transaction records of ACH POSTING (on the G/L Statement side) and FRB ACH (on the Corporate Account side).

### DETAILED DESCRIPTION OF THE PREFERRED EMBODIMENTS

The present invention will be described with reference to one particular embodiment that is an efficient computerized method for reconciling the general ledger of a corporate credit union to its corporate statement, and vice versa. However, one skilled in the art will appreciate that the invention has broader applicability to any context involving account reconciliation.

For the purposes of this specification, the following terms and/or acronyms are defined as follows (each is based upon a corporate credit union or general ledger description):

ACH POSTING is an abbreviation for Automatic Clearing House. This indicates the ACH transactions that have cleared through the Federal Reserve.

ADP TX/FINCL is an abbreviation that indicates a transaction by ADP, the payroll specialist.

AMEX TREVELERS CHEQUES is an abbreviation that indicates a transaction involving American Express Travelers Checks. This is a description that can vary depending on the company issuing the travelers checks.

ARP SETTLEMENT is an abbreviation that indicates the settlement of the ARP transactions.

ATM is an abbreviation that refers to an adjustment to the current cash balance due transactions from an automated teller machine.

CASH LETTER ADJUST occurs when the corporate credit union adjusts the amount of cash distributed or received from/to the credit union.

CASH SHIPMENT occurs when a corporate credit union distributes cash to a third party on behalf of a credit union.

CHECKS CREDIT indicates checks that have been distributed from the credit union.

CHECKS DEBIT indicates checks that have been received at the credit union.

CORPFCU is an abbreviation for corporate credit union. It indicates that the corporate credit union has issued a check.

CORPFCU CHECKS are official checks belonging to the credit union that were drawn out of the credit union's account at the corporate credit union.

CURRENCY ORDER occurs when the credit union orders cash from the corporate credit union.

CURRENCY TRANS is an abbreviation for currency transaction. In this case the corporate credit union distributes cash directly to a credit union.

ECSM VISA occurs when a credit card transaction affects the corporate account. The account name will vary depending on the type of credit card used (e.g. ECSM MasterCard).

EFS/SINGLE POINT CLEAR is an abbreviation for electronic funds transfer. The single point adjustment refers to an adjustment to the current cash balance due to transactions from an automated teller machine.

ELECTR CL PRESENT indicates the amount of official checks that have cleared for a particular day.

FRGN CASH WD is an abbreviation for foreign cash withdraw. This means that a credit union member withdrew cash from an ATM that did not belong to this credit union.

FRB ACH is an abbreviation for Federal Reserve Bank Automatic Clearing House. This indicates the ACH transactions that have cleared through the Federal Reserve.

FROM SHARES S91 indicates the percent of Mixed Deposits that the credit union did not receive credit for on the day that the corporate credit union received the funds. This percentage is usually 20% and the lead-time is normally one day.

INCOMING WIRE indicates an incoming wire transfer.

MIXED DEPOSIT indicates the value of all deposits regardless of the tender.

MIXED RETURN indicates all mixed deposits that were returned due to insufficient funds.

MONEY ORDER are check debits guaranteed by a third party.

PPD STOP PAYMENT is an abbreviation that indicates that a stop payment in the amount indicated was placed on a check.

RECPC RET LETTER is one or more returned items.

RETURN CHECKS are checks that did not clear due to insufficient funds.

S/D RETURNS are share drafts (drafts drawn on a members shares in the credit union) that are returned due to insufficient funds.

S/D SETTLEMENT is the total share drafts that were settled for a particular day.

STAFF COMPENSATION indicates funds distributed from the corporate account to cover payroll expenses.

STLMT FEE indicates a settlement fee for providing ATM services.

STOP PAYMENT indicates action initiated to stop the payment of particular check.

TRAVEL CHECKS are checks guaranteed by a third party.

UNCLASSIFIED is the holding account in which unidentified transactions are held until they can be properly classified.

VISA SUMMARY indicates a daily summary of credit card transactions.

The method may be readily implemented in software form using a variety of computer programming languages. In the present case, C++ and Visual basic were used to ensure Windows compatibility and cross-platform operation with a majority of credit union computer systems which are Unix-based. The software includes a graphical user-interface that provides simple and convenient navigation.

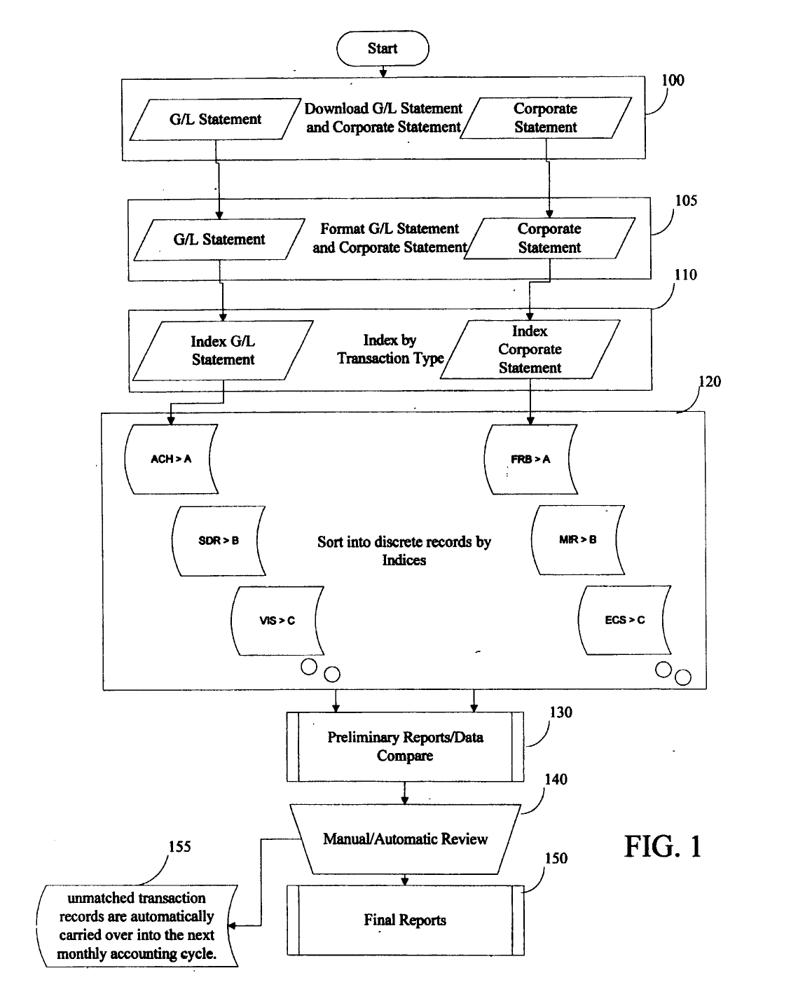

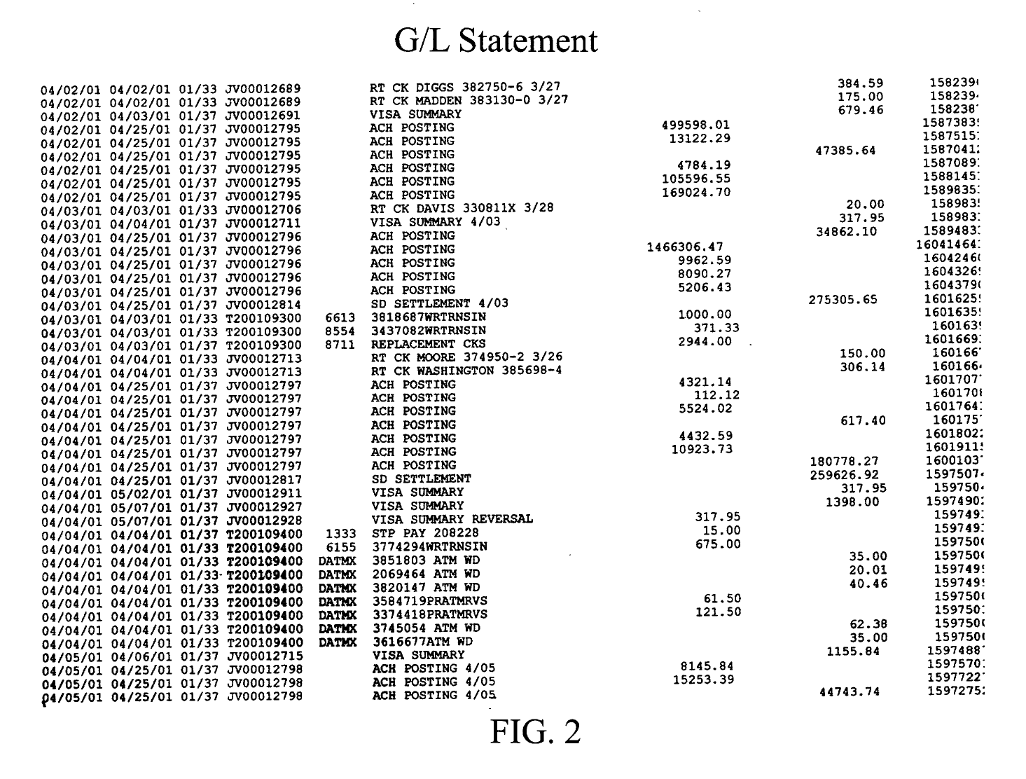

FIG. 1 illustrates a flow chart of the method according to the present invention. The method begins at step 100 with the downloading or other manner of inputting the general ledger statement (G/L Statement) and the Corporate Statement. Typically, the general ledger is maintained on a mainframe computer running a UNIX operating system, and the G/L Statement may be formatted in any number of different formats depending on the Credit Union's data processing solution. For example, the data may be formatted as EDS® Flagship data, Aftech, C.U. Processing, EDF, EDS/Charlotte, FISERV/Galaxy, Fitech, ICS, Summit, Symitar, Users, Ultradata, XP/Focus, or others. An example page from a G/L Statement is shown at FIG. 2.

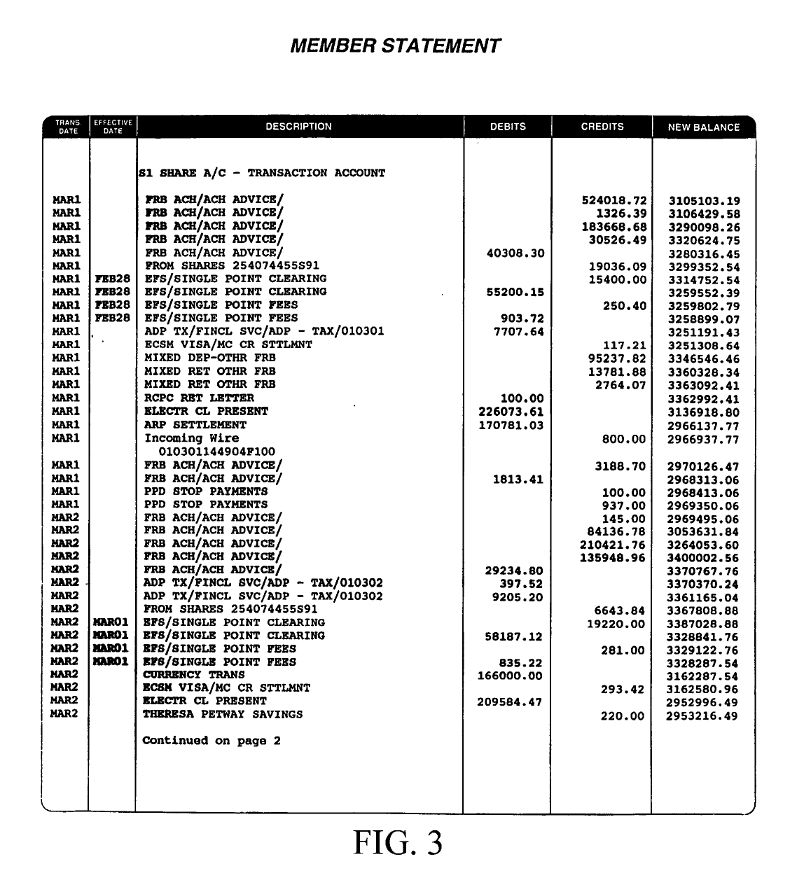

In contrast, the Corporate Statement is a monthly transaction record issued to subscribing Credit Union members by a regional Corporate Credit Union acting as a service provider, such as the Mid-Atlantic Corporate Federal Credit Union. An example page from a Corporate Statement is shown at FIG. 3.

In both cases, the downloading may be accomplished online or simply by writing the contents of both the statement and the general ledger to tape or disk storage.

At step 105, both the G/L Statement and the Corporate Statement are reformatted to unify the data fields and positions of the fields. The fields used are essentially as shown in FIG. 3 and include Transaction Date; Effective Date; Description, Debits; Credits; Balance.

At step 110, the method performs an indexing routine on each line item appearing in both the G/L Statement and the Corporate Statement. The indexing routine assigns an arbitrary index letter to each line item depending on transaction type as identified in the Description field. Currently, fourteen indices are being used and are assigned letters A through N, although different and/or additional indices may be used. Generally, each transaction type appearing in both the G/L Statement and the Corporate Statement is assigned a unique index (A-N), although certain transaction types are grouped under a single index. In the G/L statement, the transaction types may fall into any one of eighteen (18) existing categories plus a catch-all N/A (non-assigned) category, the eighteen being identified by acronym as follows:

| | |
|---|---|
| m_o // money order | STL // stlmt fee |
| ACH // ach posting | FRG // frgn cash wd |
| VIS // visa summary | TCK // traveler check |
| SDS // s/d settlement | CUR // currency order |
| SDR // s/d returns | ATM // atm |
| RTC // return check | MAR // macfcu checks (arp) |
| STP // stop payment | MDY (D) // |
| MAC // macfcu | MDY (C) // |
| INC // incoming wire | |
| STC // staff compensation | |

Thus, on the G/L statement side, indexes are assigned as follows:

| | |
|---|---|
| ACH // ach posting > | A |
| SDR // s/d returns > | B |
| VIS // visa summary > | C |
| TCK // traveler check > | D |
| RTC // return check > | E |
| SDS // s/d settlement > | F |
| STP // stop payment > | G |
| m_o // money order > | H |
| MAR // macfcu checks (arp) > | H |
| MDY (D) // > | H |
| MDY (C) // | I |
| MAC // macfcu > | J |
| STC // staff compensation | J |
| CUR // currency order > | K |
| INC // incoming wire > | L |
| ATM // atm > | M |
| STL // stlmt fee > | M |
| FRG // frgn cash wd > | M |
| N/A // non-assigned > | N |

Likewise, in the Corporate Statement, the transaction type may fall into any one of sixteen (16) existing categories plus a catch-all (unclassified) category, the sixteen being identified by acronym as follows:

| | | |
|---|---|---|
| FRB // frb ach | INC // incoming wire | RCP // recpc ret letter |
| ADP // adp tx/fincl | FRS // from shares | ELE // electr cl present |
| EFS // efs/single | CUR // currency trans | CAL // cash letter |
| point clear | | adjust |
| ECS // ecsm visa | ARP // arp settlement | CAS // cash shipment |
| MID // mixed dep | PPD // ppd stop payments | AME // amex travelers |
| MIR // mixed ret | | cheques |

On the Corporate Statement side, indexes are assigned as follows:

| | |
|---|---|
| FRB // frb ach > | A |
| MIR // mixed ret > | B |
| ECS // ecsm visa > | C |
| AME // amex travelers cheques > | D |
| RCP // recpc ret letter > | E |
| ELE // electr cl present > | F |
| CAL // cash letter adjust > | F |
| PPD // ppd stop payments > | G |
| ARP // arp settlement > | H |
| FRS // from sharesMID // mixed dep > | I |
| MID // mixed dep > | I |
| ADP // adp tx/fincl > | J |
| CUR // currency trans > | K |
| CAS // cash shipment > | K |
| INC // incoming wire > | L |
| EFS // efs/single point clear > | M |
| N/A (unclassified) > | N |

Thus, a total of twenty-eight new records are created to store the sorted data for both the Corporate Statement and the General Ledger. In addition, the individual data records are grouped together in a Database.

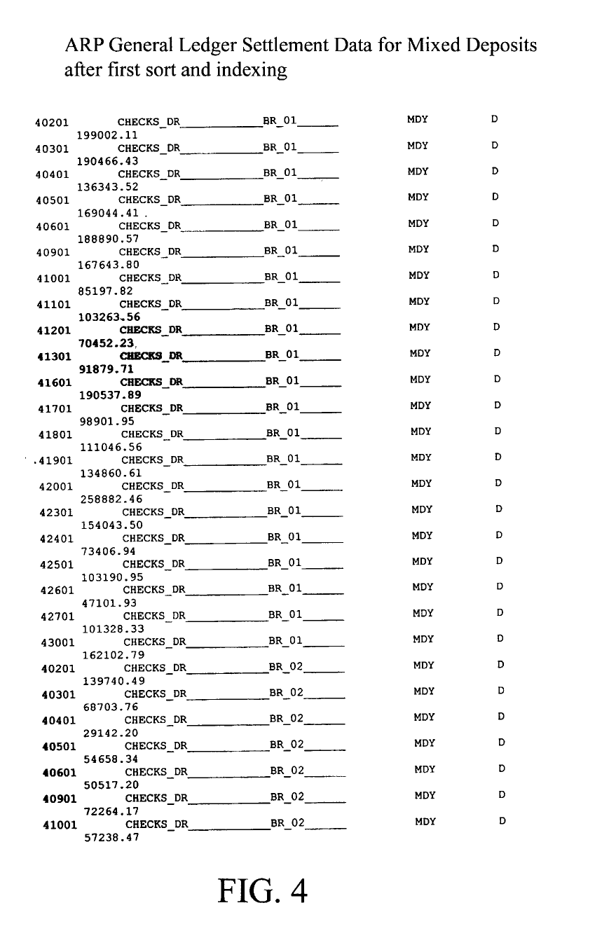

FIG. 4 is a resultant printout of the record containing the general ledger data for mixed deposits after both the first sort and indexing. The first column reflects the transaction date (e.g., 40201), the second column reflects the amount of the transaction (199002.11), the third column reflects the transaction type (CHECKS_DR BR_{—}01_, the fourth column reflects the transaction type acronym (MDY), and the fifth column reflects an assigned credit/debit value (C or D).

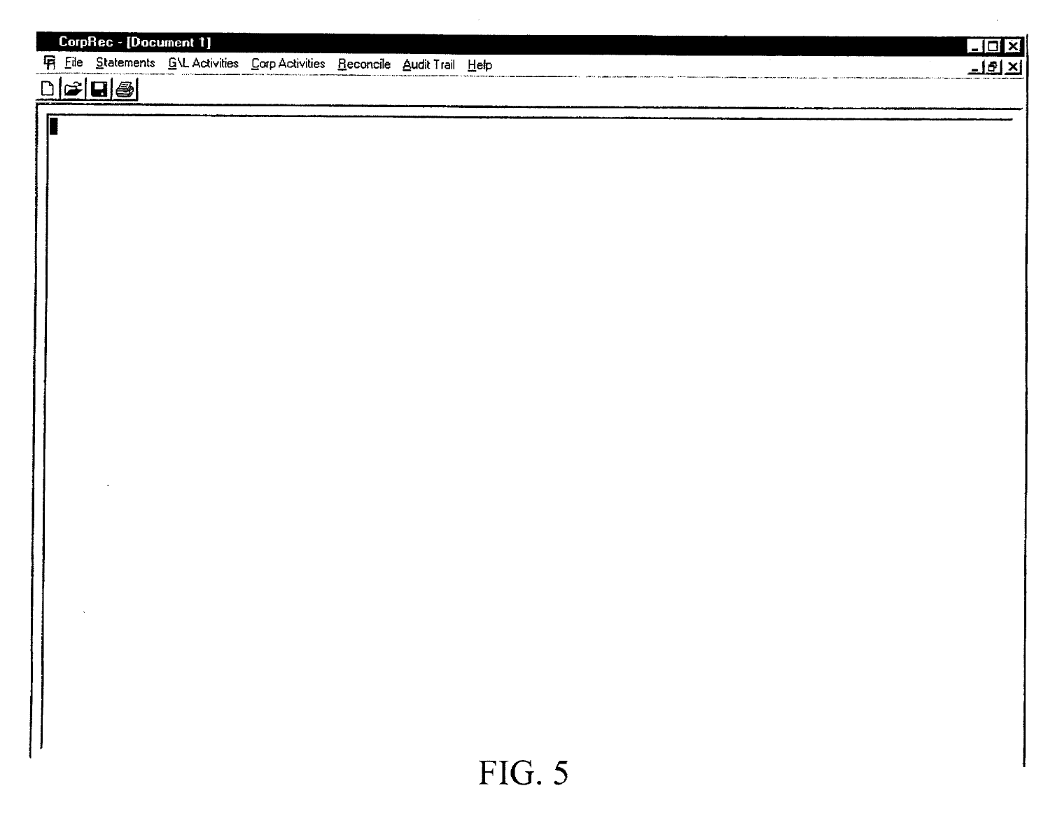

FIGS. 5-19 are screen prints illustrating the various navigation choices and reports made available to the user throughout the software implementation of the present method.

At step 130, A Navigation Menu is made available to the user via a user interface as depicted in FIG. 5. The Navigation Menu provides a graphical menu for accessing a given Database, inclusive of either the raw G/L Statement or the Corporate Statement, or any of the individual separate files or records generated at step 120. A menu bar reflecting a series of global commands are shown to the upper left.

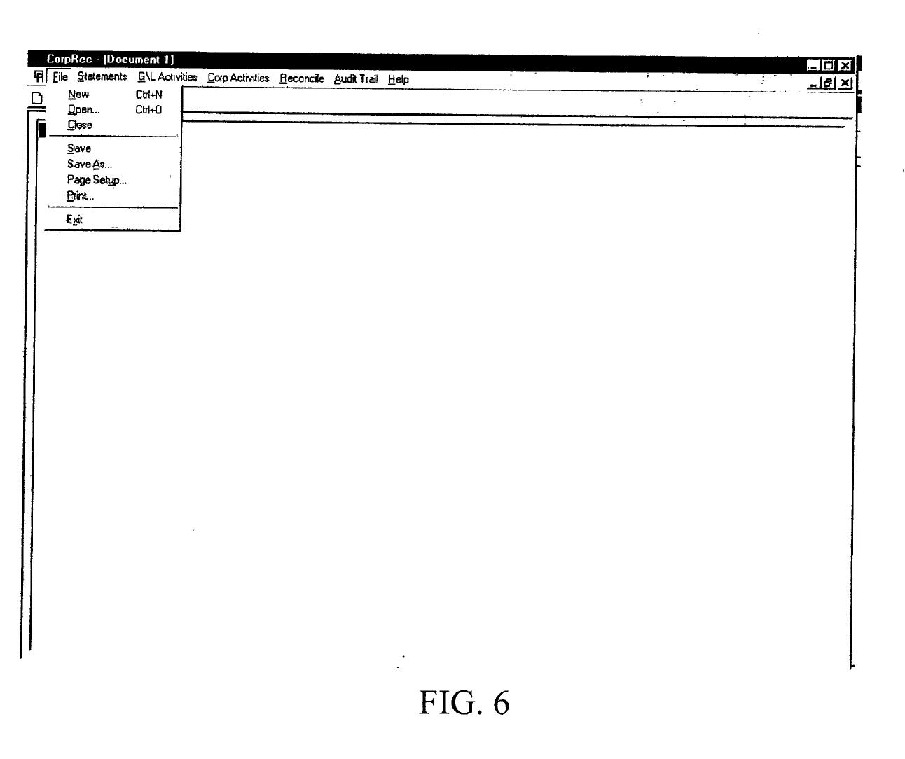

Clicking the File command causes the drop-down list of file operation sub-commands shown at FIG. 6, inclusive of New, Open, Close, Save, Save As, Page Setup, Print and Exit. The New, Open, Close, Save and Save As are standard file operators for opening, closing and saving a given database. Page Setup allows a variety of display options, Print allows printing of the current screen, and Exit exits the current screen.

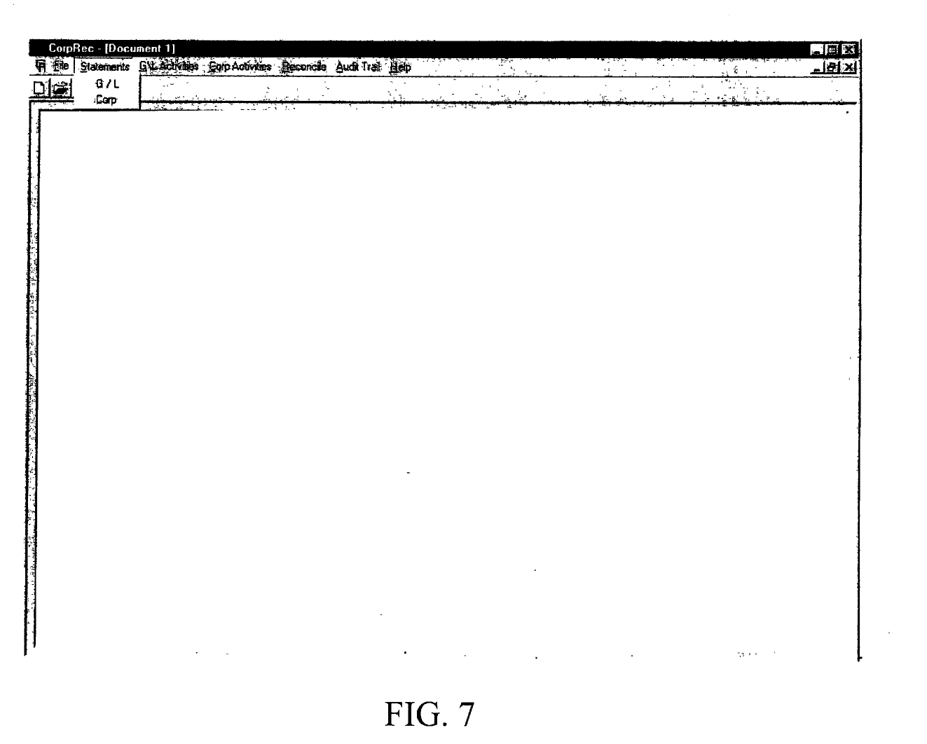

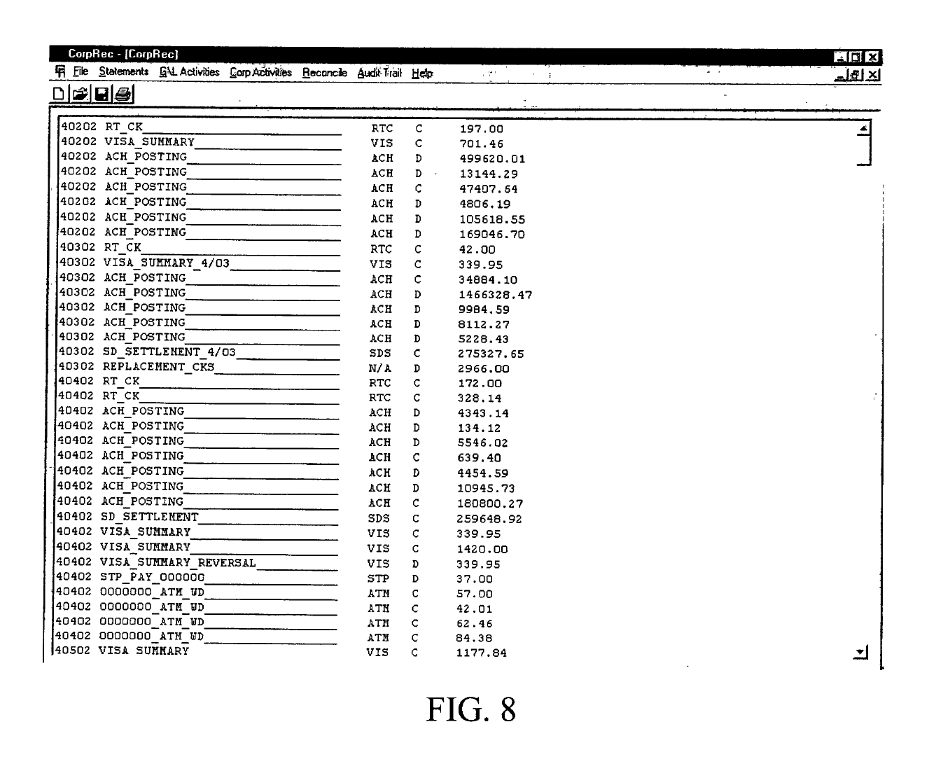

Clicking the Statements command causes the drop-down list of statement sub-commands shown at FIG. 7, inclusive of G/L Statement and Corporate Statement. By clicking on the G/L Statement link the user is shown the indexed G/L Statement as in FIG. 8. Similarly, by clicking on the Corporate Statement link the user is shown the indexed Corporate Statement. To the right-hand side, a cross-reference of ledger activities is shown inclusive of the assigned Index letter, the G/L activity to which that Index has been assigned, and the corresponding Corporate Statement Activity to which that same Index has been assigned. For example, for Index A, the G/L ACTIVITIES will show the ACH POSTING, while the CORP ACTIVITIES will show the FRB ACH.

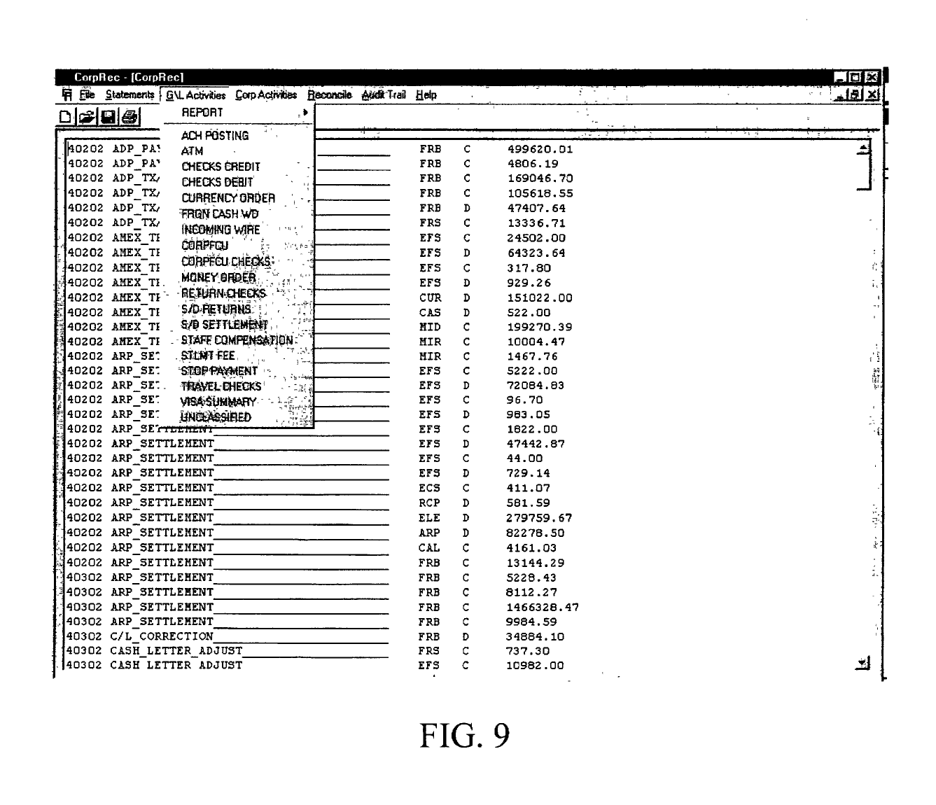

Clicking the G/L Activities command causes the drop-down list of G/L-related reports shown at FIG. 9. Clicking on the Reports menu item provides a choice of a CREDIT report for the G/L Statement and a DEBIT report for the G/L Statement. Other report choices include a DB POSTING report for the G/L Statement, two MATCHED transaction reports, one for matching Debits as appearing on the G/L Statement, and one for matching credits, and four OUTSTANDING transaction reports of unmatched transactions appearing in the G/L Statement, one report for G/L CREDIT (unmatched credits appearing in the G/L Statement), one for G/L DEBIT (unmatched debits appearing in the G/L Statement). Each of the two MATCHED transaction reports may be structured in three ways—as a one-to-one match, a daily total match, or a one-to-many match. Other report choices include ACH POSTING, ATM, CHECKS CREDIT, CHECKS DEBIT, CURRENCY ORDER, FRGN CASH WD, INCOMING WIRE, CORPFCU, CORPFCU CHECKS, MONEY ORDER, RETURN CHECKS, S/D RETURNS, S/D SETTLEMENT, STAFF COMPENSATION, STLMT FEE, STOP PAYMENT, TRAVEL CHECKS, and VISA SUMMARY.

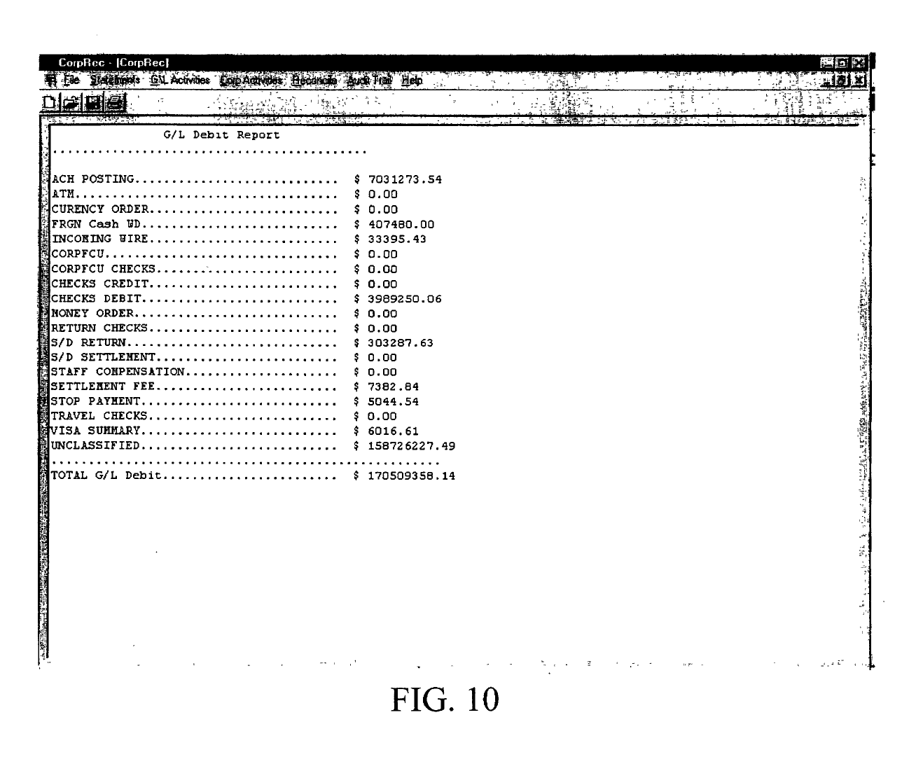

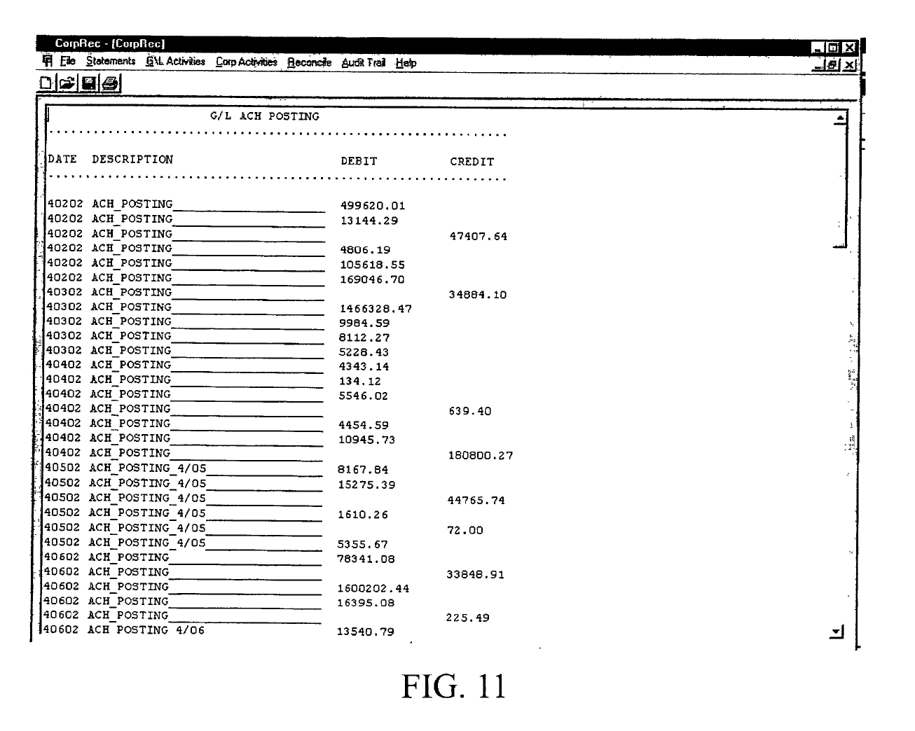

If the user attempts to access any of the aforementioned reports, at step 130 the appropriate records from each of the twenty-eight created at step 120 is filtered, sorted and output to the user in chronological report format on the right hand side of the user interface. Thus, for example, if the user selects the G/L Statement and a DEBIT report for the G/L Statement is calculated in real time and is output as shown in FIG. 10. If the user selects G/L Activities>ACH POSTING, a detailed report of postings for the G/L Statement is calculated in real time and is output as shown in FIG. 11.

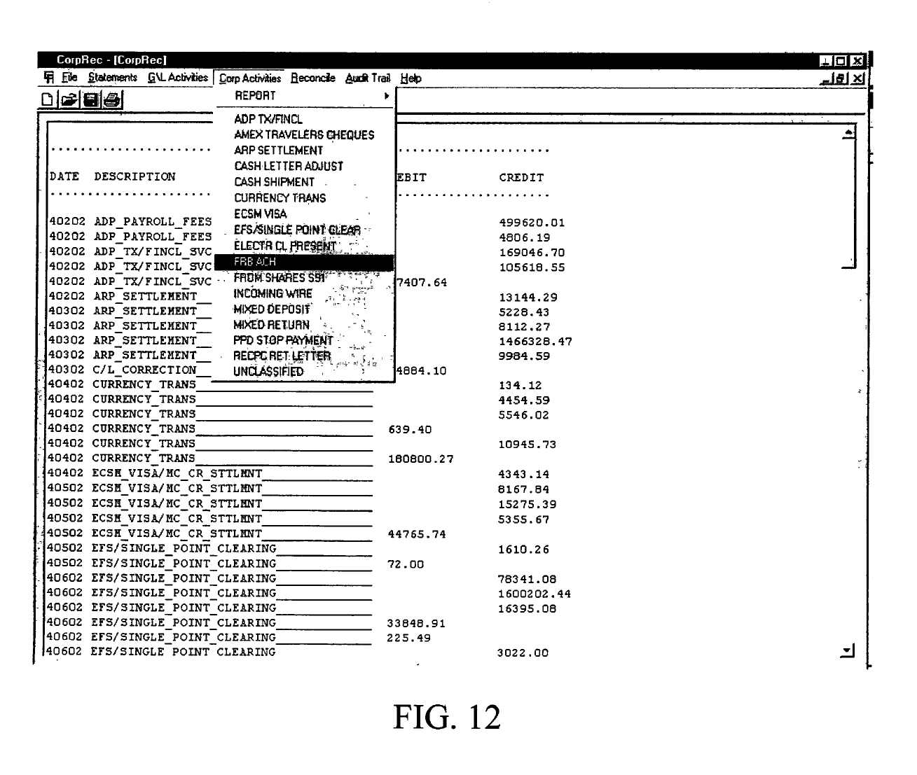

Referring back to FIG. 5, clicking the Corp Activities command causes the drop-down list of Corporate Activities shown at FIG. 12. Clicking on the Reports menu item provides a choice of a CREDIT report for the Corporate Activities Statement and a DEBIT report for the Corporate Activities Statement. Other report choices include ADP TX/FINCL, AMEX TRAVELERS CHEQUES, ARP SETTLEMENT, CASH LETTER ADJUST, CASH SHIPMENT, CURRENCY TRANS, ECSM VISA, EFS/SINGLE POINT CLEAR, ELECTR CL PRESENT, FRB ACH, FROM SHARES S91, INCOMING WIRE, MIXED DEPOSIT, MIXED RETURN, PPD STOP PAYMENT, and RECPC RET LETTER.

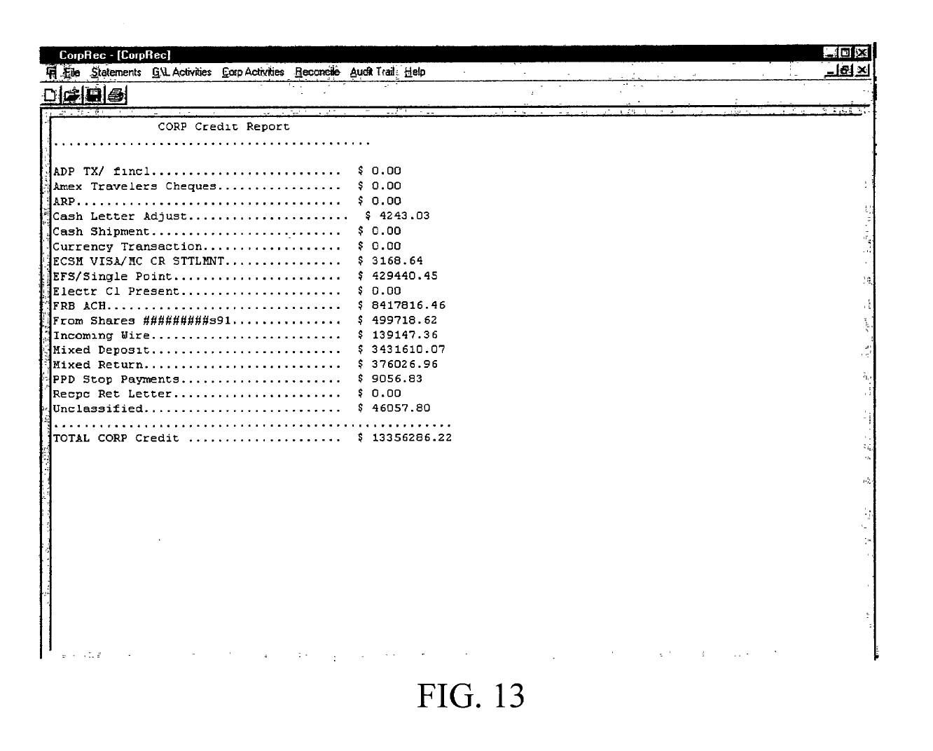

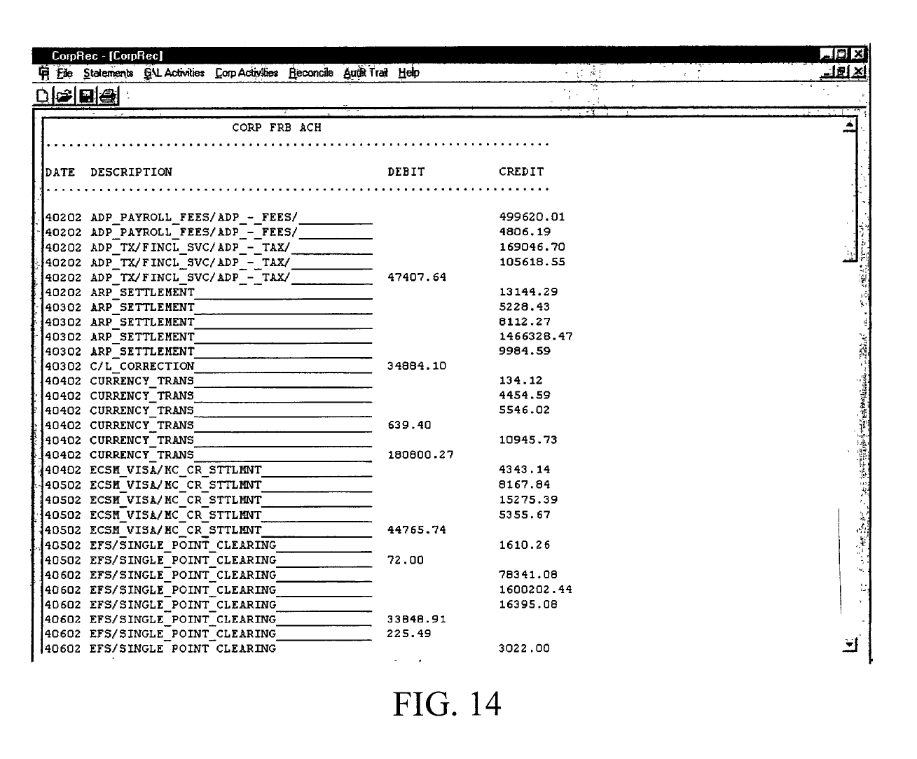

As with the G/L Statement, if the user attempts to access any of the aforementioned Corporate Activities reports, as shown at step 130 the appropriate records from each of the twenty-eight created at step 120 is filtered, sorted and output to the user in chronological report format on the right hand side of the user interface. Thus, for example, if the user selects the Corporate Activities and a CREDIT report for the Corporate Activities Statement, a listing of credit entries is calculated in real time and is output as shown in FIG. 13. If the user selects G/L Activities>ACH POSTING, a detailed report of postings for the G/L Statement is calculated in real time and is output as shown in FIG. 14.

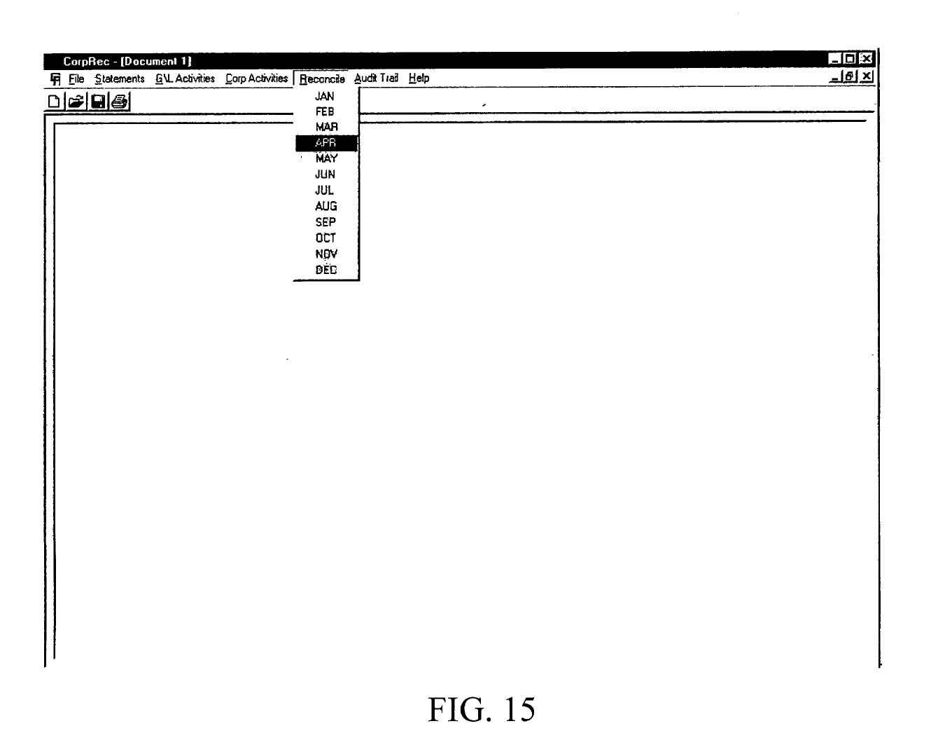

Referring back to FIG. 5, the user begins a reconciliation by clicking the Reconcile command (see also FIG. 1 at step 130). This causes the drop-down list of calendar months shown at FIG. 15. In accordance with the present invention, the user simply clicks on the month to be reconciled, and a comparison engine is applied to the appropriate records from step 120. The comparison engine tries to match identical amounts appearing in the correspondingly-indexed records of the G/L Statement and Corporate Statement.

The comparison engine then writes each pair of matching items from the general ledger and the corporate statement out to a matching transaction record (eighteen of such records total for corresponding transaction types). The following data is illustrative of exemplary matching transaction records of ACH//ach posting transactions in the General Ledger to the FRB//frb ach transactions in the Corporate Statement:

| | | |
|---|---|---|
| 31201 | ACH_POSTING | C → 48.17 |
| MAR12 | FRB ACH/ACH ADVICE/ | D → 48.17 |
| 31901 | ACH_POSTING | C → 101.00 |
| MAR19 | FRB ACH/ACH ADVICE/ | D → 101.00 |
| 30901 | ACH_POSTING | C → 203.49 |
| MAR9 | FRB ACH/ACH ADVICE/ | D → 203.49 |
| 32301 | ACH_POSTING | C → 203.49 |
| MAR9 | FRB ACH/ACH ADVICE/ | D → 203.49 |
| 30601 | ACH_POSTING | C → 251.00 |
| MAR6 | FRB ACH/ACH ADVICE/ | D → 251.00 |
| 30201 | ACH POSTING | C → 417.54 |
| MAR2 | FRB\hat{ }ACH/ACH ADVICE/ | D → 417.54 |
| 32001 | ACH_POSTING | C → 597.14 |
| MAR20 | FRB ACH/ACH ADVICE/ | D → 597.14 |

It can be seen that each matching line item credit is properly matched with each corresponding line item debit.

All of the leftover pairs of unmatched transactions are written out to an outstanding transaction record (all unmatched transaction records are consolidated). The following data shows an exemplary unmatched transaction record.

| APR12 | FRB_ACH/ACH ADVICE/ | D → 48.17 |
|---|---|---|
| APR26 | FRB_ACH/ACH ADVICE/ | D → 50.00 |
| APR20 | FRB ACH/ACH ADVICE/ | D → 203.49 |
| APR12 | FRB_ACH/ACH ADVICE/ | D → 899.00 |
| 41701 | ACH POSTING | C → 1598.66 |
| APR17 | FR& ACH/ACH ADVICE/ | D → 1598.86 |
| 42301 | ACH_POSTING | C → 3931.76 |
| 41001 | ACH_POSTING | C → 7899.64 |
| APR23 | FRB_ACH/ACH ADVICE/ | D → 28061.57 |
| 42701 | ACH_SETTLEMENT | C → 141277.78 |
| 42601 | ACH_SETTLEMENT | C → 181749.91 |
| 42401 | ACH_RETURNS_CREDIT 4/19 | D → 80.35 |
| 40601 | ACH_POSTING-4/06 | D → 893.57 |

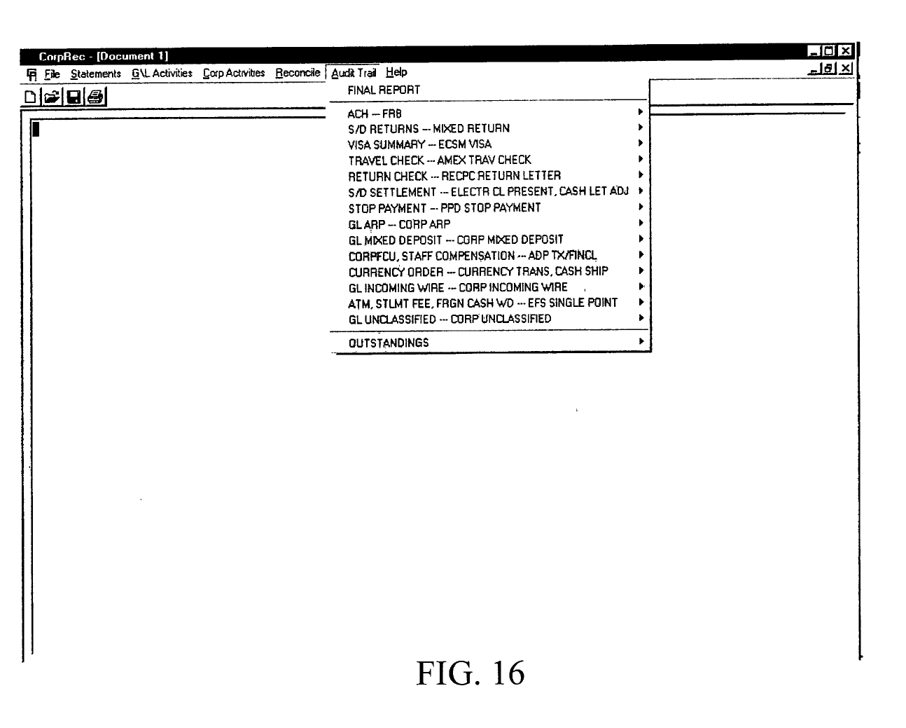

Referring back to FIG. 5, the user can tabulate the results and acquire the Reconciliation statement or any of a variety of breakdown reports by clicking on the Audit Trail command. This causes the drop-down list of report types shown in FIG. 16, inclusive of the following reports: Final Report, ACH—FRB, S/D Returns—Mixed Return, VISA Summary—ECSM VISA, Travel Checks—Amex Travelers Checques, Return Checks—Recpc Ret Letter, S/D Settlement—Electr Cl Present, Cash Letter Adjust, Stop Payment—Ppd Stop Payment, G/L ARP Settlement—Corp ARP Settlement, G/L Mixed Deposit—Corp Mixed Deposit, CORPFCU, Staff Compensation-ADP Tx/Fincl, Currency Order—Currency Trans, Cash Shipment, G/L Incoming Wire—Corp Incoming Wire, ATM, Stlmt Fee, Frgn Cash Wd—EFS/Single Point Clear, G/L Unclassified—Corp Unclassified, and Outstandings.

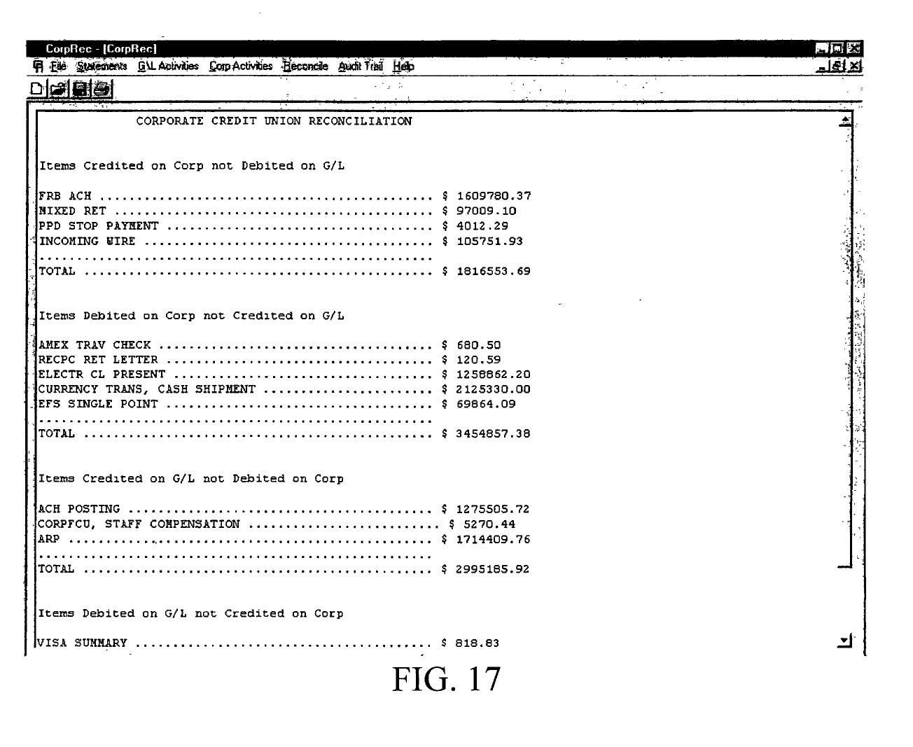

FIG. 17 illustrates the Final Report which is a complete Reconciliation statement.

All of the Breakdown reports are available to the user depending on the type of the MATCHED or OUTSTANDING transaction reports selected per the user interface as in FIG. 5 during step 130.

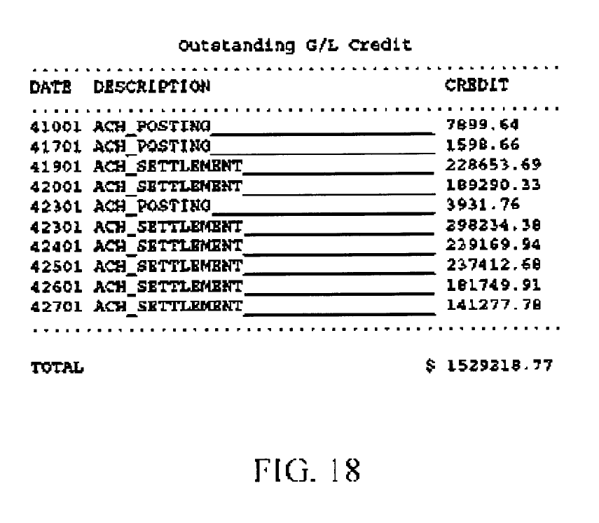

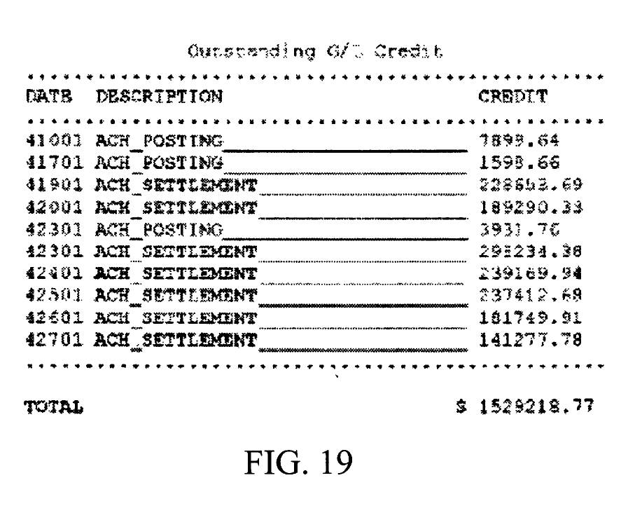

For example, if the user selects index ACH POSTING (on the G/L Statement side) and FRB ACH (on the Corporate Account side), a report is prepared from the matching transaction records of ACH II ach posting transactions in the General Ledger to the FRB 11 frb ach transactions in the Corporate Statement (example appearing above) and is presented to the user as shown in FIG. 18. Again, it can be seen that each matching line item credit on the G/L Statement is matched with a corresponding debit on the Corporate Account side. Similarly, indexed OUTSTANDING transaction reports can be selected per the user interface as in FIG. 5 during step 130. For example, if the user selects index ACH POSTING (on the G/L Statement side) and FRB ACH (on the Corporate Account side), and then selects the OUTSTANDING G/L CREDITs, a report is prepared from the unmatched transaction records of ACH II ach posting transactions in the General Ledger to the FRB II frb ach transactions in the Corporate Statement (same example appearing above) and is presented to the user as shown in FIG. 19. A list of outstanding (unmatched) G/L credits is displayed.

At this point, and as shown at step 140 in FIG. 1, the user will preferably review both the MATCHED and OUTSTANDING transaction reports and will manually alter any MATCHED line items that are incorrectly matched, or OUTSTANDING line items that were not matched and should have been. This process can be facilitated by further display screens and/or automated to a large extent.

At step 150, following any manual or semi-automatic quality assurance changes, final reports can be generated and printed in accordance with the needs of the user and/or the Credit Union.

Typically, unmatched items should be carried over into the next monthly accounting cycle so that they can be cleared. However, it is very common for accountants to forget to do this when they are manually keeping the books. The present system automatically remembers to do this. As shown at step 155, the unmatched transaction records are automatically carried over into the next monthly accounting cycle.

Thus, the invention provides a novel approach to reconciling the corporate credit union account by re-formatting, indexing and segregating like items from the G/L statement and the credit union Corporate Statement. These items are crossed matched and all remaining items are kept considered outstanding items. The re-formatting, indexing and segregating greatly reduces the number of machine code comparisons significantly and speeds the processing time.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for reconciling a G/L Statement to a Corporate Statement, comprising the steps of:
inputting member credit union transaction statement data and general ledger data;
reformatting said G/L Statement and Corporate Statement to unify the data fields and positions of the fields;
performing an indexing routine on said reformatted G/AL Statement and Corporate Statement and attaching an indicator to line items therein distinguishing as credit or debit, and by transaction type;
performing a sort routine on said reformatted and indexed G/L Statement and Corporate Statement, and thereby sorting said reformatted and indexed data into discrete records;
comparing each sorted and indexed record from the G/L Statement with a corresponding sorted and indexed record from the Corporate Statement and writing each matched transaction to one or more matching records, and writing each unmatched transaction to an unmatched record;
compiling a reconciliation report from said matching records and unmatched record.

2. The method for reconciling a G/L Statement to a Corporate Statement according to claim 1, wherein said step of performing an indexing routine categorizes said line items in any one of eighteen (18) defined transaction types plus a catch-all non-assigned category.

3. The method for reconciling a G/L Statement to a Corporate Statement according to claim 1, wherein said step of reformatting further comprises defining and populating at least the following fields from said G/L Statement and said Corporate Statement: Transaction Date; Effective Date; Description, Debit; Credit; Balance.

4. The method for reconciling a G/L Statement to a Corporate Statement according to claim 1, further comprising the step of selectively displaying any one of a group of G/L Statement reports including a credit report, a debit report, a DB posting report, a matched transaction report, a matching debit report, a matching credit report, and an outstanding transaction report.

5. The method for reconciling a G/L Statement to a Corporate Statement according to claim 1, further comprising the step of selectively displaying any one of a group of Corporate Statement reports including a credit report, a debit report, an ADP Tx/fincl report, an Amex Travelers Cheques report, an ARP Settlement report, a Cash Letter Adjust report, a Cash Shipment report, a Currency Trans report, an ECSM Visa report, an EFS/single Point Clear report, an Electrical Present report, an FRB ACH report, a from Shares S91 report, an Incoming Wire report, and a Mixed report.

6. A method for reconciling a G/L Statement to a Corporate Statement, comprising the steps of:
inputting a G/L Statement and a Corporate Statement;
performing an indexing routine on said G/L Statement and Corporate Statement and classifying said line items as credit or debit, and categorizing said line items by transaction type and appending fields thereto in accordance with said categorization and classification;
performing a sort routine on said indexed G/L Statement and Corporate Statement, and thereby sorting said indexed data into discrete records;
comparing each sorted and indexed record from the G/L Statement with a corresponding sorted and indexed record from the Corporate Statement and writing each matched transaction to a matched transaction record, and writing each unmatched transaction to an unmatched transaction record;
compiling a reconciliation report from said matching records and unmatched record.

7. The method for reconciling a G/L Statement to a Corporate Statement according to claim 6, wherein said indexing routine categorizes said line items in any one of eighteen (18) defined categories plus a catch-all non-assigned category.

8. The method for reconciling a G/L Statement to a Corporate Statement according to claim 6, further comprising the step of reformatting said G/L Statement and said Corporate Statement to unify the data fields and positions of the fields.

9. The method for reconciling a G/L Statement to a Corporate Statement according to claim 8, wherein said step of reformatting further comprises defining and populating at least the following fields from said G/L Statement and said Corporate Statement: Transaction Date; Effective Date; Description, Debit; Credit; Balance.

10. The method for reconciling a G/L Statement to a Corporate Statement according to claim 6, further comprising the step of selectively displaying any one of a group of G/L Statement reports including a credit report, a debit report, a DB posting report, a matched transaction report, a matching debit report, a matching credit report, and an outstanding transaction report.

11. The method for reconciling a G/L Statement to a Corporate Statement according to claim 6, further comprising the step of selectively displaying any one of a group of Corporate Statement reports including a credit report, a debit report, an ADP Tx/fincl report, an Amex Travelers Cheques report, an ARP Settlement report, a Cash Letter Adjust report, a Cash Shipment report, a Currency Trans report, an ECSM Visa report, an EFS/single Point Clear report, an Electrical Present report, an FRB ACH report, a from Shares S91 report, an Incoming Wire report, and a Mixed report.
